(19) United States
(12) Patent Application Publication
(10) Pub. No.: US 2024/0162427 A1
(43) Pub. Date: May 16, 2024

(54) NEGATIVE ELECTRODE ACTIVE MATERIAL AND BATTERY

(71) Applicants: Panasonic Holdings Corporation, Osaka (JP); TOYOTA JIDOSHA KABUSHIKI KAISHA, Aichi (JP)

(72) Inventors: Hiroki YABE, Osaka (JP); Masaki HIRASE, Hyogo (JP); Yusuke ITO, Nara (JP); Takamasa OHTOMO, Okazaki-shi (JP)

(21) Appl. No.: 18/415,144

(22) Filed: Jan. 17, 2024

Related U.S. Application Data
(63) Continuation of application No. PCT/JP2022/021995, filed on May 30, 2022.

(30) Foreign Application Priority Data
Jul. 20, 2021 (JP) 2021-119654

(51) Int. Cl. H01M 4/38; H01M 4/02; H01M 4/36; H01M 10/052; H01M 10/0562

(52) U.S. Cl. CPC H01M 4/386; H01M 4/366; H01M 10/052; H01M 10/0562; H01M 2004/028; H01M 2300/008

(57) ABSTRACT

A negative electrode active material according to one aspect of the present disclosure includes: a porous silicon particle; and a solid electrolyte, wherein the porous silicon particle has a plurality of pores, the solid electrolyte has a shape of a thin film that covers at least a part of an inner surface of each of the pores, and the thin film has an average thickness of less than 30 nm.

This application is a continuation of PCT/JP2022/021995 filed on May 30, 2022, which claims foreign priority of Japanese Patent Application No. 2021-119654 filed on Jul. 20, 2021, the entire contents of both of which are incorporated herein by reference.

### BACKGROUND OF THE INVENTION

### 1. Field of the Invention

The present disclosure relates to a negative electrode active material and a battery.

### 2. Description of Related Art

JP 2012-084522 A discloses a negative electrode for lithium-ion secondary batteries, wherein at least one surface of a current collector includes a porous silicon particle having a three-dimensional network structure.

JP 2020-021674 A discloses a negative electrode layer that includes an Si-based active material having a surface on which a coating layer including a solid electrolyte is formed.

### SUMMARY OF THE INVENTION

Conventional techniques are required to improve charge-discharge cycle characteristics of a battery that uses silicon as an active material.

A negative electrode active material according to one aspect of the present disclosure includes:
a porous silicon particle; and
a solid electrolyte, wherein
the porous silicon particle has a plurality of pores,
the solid electrolyte has a shape of a thin film that covers at least a part of an inner surface of each of the pores, and
the thin film has an average thickness of less than 30 nm.

The present disclosure can improve charge-discharge cycle characteristics of a battery that uses silicon as an active material.

### BRIEF DESCRIPTION OF THE DRAWINGS

FIG. 1A is a cross-sectional view schematically showing a configuration of a negative electrode active material of Embodiment 1.

FIG. 1B is a cross-sectional view schematically showing a configuration of a porous silicon particle of Embodiment 1.

FIG. 2 is a flow chart of a method for producing the negative electrode active material of Embodiment 1.

FIG. 3 is a cross-sectional view schematically showing a configuration of a battery of Embodiment 2.

### DETAILED DESCRIPTION

(Findings on which the Present Disclosure is Based)

In all-solid-state lithium-ion batteries, both electrons and lithium ions are required to be efficiently supplied to an active material in an electrode. In all-solid-state lithium-ion batteries, active materials are dispersed in an electrode. A common negative electrode desirably has both an electron conduction path formed of an active material and a conductive additive that are in contact with each other and an ion conduction path formed of solid electrolytes joined to each other.

Silicon particles are sometimes used as a negative electrode active material. Silicon particles can occlude lithium ions by being alloyed with lithium. Silicon particles can better enhance the capacity of a battery than other active materials such as graphite.

A silicon particle expands at the time of charging when occluding lithium and shrinks at the time of discharging when releasing lithium. Accordingly, the repeated volume changes of the silicon particle through the charge-discharge cycle adversely affect the state of contact between the silicon particle and a conductive additive and that between the silicon particle and a solid electrolyte. That is, an interface between the silicon particle and the conductive additive and that between the silicon particle and the solid electrolyte are lessened. This deteriorates the performance of a battery.

In order to avoid such a problem, there have been made various proposals aiming at reducing the volume changes due to the expansion and shrinkage of the silicon particle at the time of charging and discharging.

In JP 2012-084522 A, a porous silicon particle having a three-dimensional network structure is used as a negative electrode active material so as to ensure a void in the three-dimensional network structure as a space for expansion at the time of charging. In JP 2020-021674 A, a coating layer including a solid electrolyte is formed on an outer circumference of an Si-based active material by a dry method so as to generate tiny pores around the Si-based active material and thus ensure the tiny pores as a space for expansion at the time of charging.

From the viewpoint of lithium ion transport, it is important that a negative electrode active material and a solid electrolyte should be in a favorable state of contact with each other in a negative electrode. However, the porous silicon particle disclosed in JP 2012-084522 A has a rugged shape on a surface thereof. The coated Si-based active material disclosed in JP 2020-021674 A has tiny pores around itself. Therefore, both of the negative electrode active materials are unlikely to be in a favorable contact with a solid electrolyte. In addition, in these negative electrode active materials, lithium ions travel between a surface layer of the silicon particle and the solid electrolyte, and therefore, the surface layer of the silicon particle tends to have expansion and shrinkage rates higher than those of an inside of the silicon particle. Thus, there is a risk that local expansion and shrinkage may occur on a surface layer of the negative electrode active material. Accordingly, the performance of a battery is likely to be deteriorated when the charge-discharge cycle is repeated.

The present inventors have made intensive studies on techniques for improving the charge-discharge cycle characteristics of a battery. As a result, they have arrived at the technique of the present disclosure.

### SUMMARY OF ONE ASPECT ACCORDING TO THE PRESENT DISCLOSURE

A negative electrode active material according to a first aspect of the present disclosure includes:
a porous silicon particle; and
a solid electrolyte, wherein
the porous silicon particle has a plurality of pores,
the solid electrolyte has a shape of a thin film that covers at least a part of an inner surface of each of the pores, and
the thin film has an average thickness of less than 30 nm.

In the above configuration, the solid electrolyte covers, in the shape of a thin film, at least a part of the inner surface of each of the pores of the porous silicon particle, and therefore a lot of interfaces, that is, a lot of ion conduction paths, are formed between the porous silicon particle and the solid electrolyte. This makes it possible to transport lithium ions even into the pores of the porous silicon particle, enhancing the ionic conductivity of the negative electrode active material. Moreover, charge and discharge reactions can be made smoothly at a lot of these interfaces, reducing the occurrence of the local expansion and shrinkage of the negative electrode active material. Thereby, the charge-discharge cycle characteristics of a battery are improved.

Also, in the above configuration, the thin film of the solid electrolyte is sufficiently thin, allowing the pores to be maintained sufficiently in the negative electrode active material. Thereby, a space for expansion at the time of charging can be ensured sufficiently in the negative electrode active material.

According to a second aspect of the present disclosure, for example, in the negative electrode active material according to the first aspect, a ratio of a pore volume of the negative electrode active material to a pore volume of the porous silicon particle may be 55% or more and less than 99%. The above configuration makes it possible to sufficiently provide interfaces for ion transport even inside the porous silicon particle while ensuring the space for expansion at the time of charging in the negative electrode active material. As a result, the charge-discharge cycle characteristics of a battery can be further improved.

According to a third aspect of the present disclosure, for example, in the negative electrode active material according to the first or second aspect, a ratio of a specific surface area of the negative electrode active material to a specific surface area of the porous silicon particle may be 55% or more and less than 99%. The above configuration makes it possible to sufficiently provide interfaces for ion transport even inside the porous silicon particle while ensuring the space for expansion at the time of charging in the negative electrode active material. Moreover, since the specific surface area of the negative electrode active material is smaller than that of the porous silicon particle, the negative electrode active material is more likely to be brought into contact with another solid electrolyte in the negative electrode than when only the porous silicon particle is used as the negative electrode active material. As a result, the charge-discharge cycle characteristics of a battery can be further improved.

According to a fourth aspect of the present disclosure, for example, in the negative electrode active material according to any one of the first to third aspects, a ratio of a volume of the solid electrolyte to a volume of the porous silicon particle may be 0.5% or more and less than 15%. The above configuration makes it possible to enhance the ionic conductivity while reducing a decrease in capacity density of the negative electrode active material.

According to a fifth aspect of the present disclosure, for example, in the negative electrode active material according to any one of the first to fourth aspects, the solid electrolyte may include lithium, phosphorus, sulfur, and halogen. The above configuration makes it possible to enhance the ionic conductivity of the negative electrode active material.

A battery according to a sixth aspect of the present disclosure includes:
a negative electrode;
a positive electrode; and
an electrolyte layer disposed between the negative electrode and the positive electrode, wherein
the negative electrode includes the negative electrode active material according to any one of the first to fifth aspects.

The above configuration can make it possible to improve the charge-discharge cycle characteristics of a battery.

A negative electrode active material according to a seventh aspect of the present disclosure includes:
a porous silicon particle; and
a solid electrolyte, wherein
the porous silicon particle has a plurality of pores, and
the solid electrolyte has a shape of a thin film that covers at least a part of an inner surface of each of the pores.

Hereinafter, embodiments of the present disclosure will be described with reference to the drawings.

### Embodiment 1

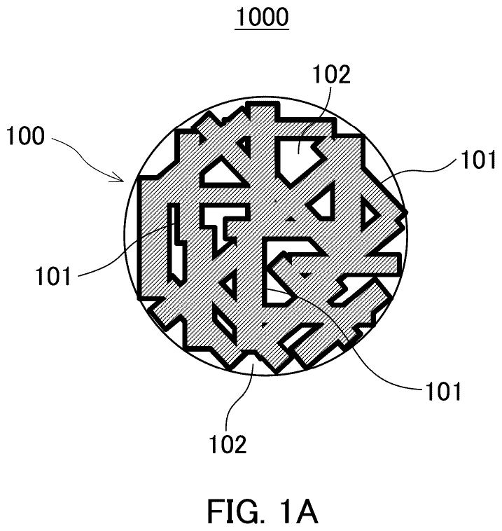

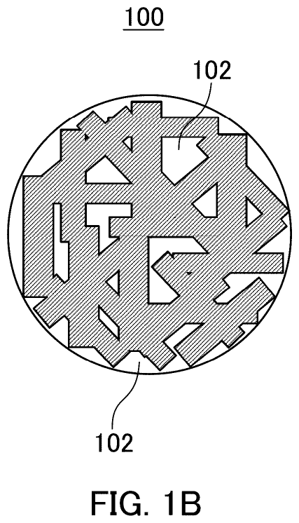

FIG. 1A is a cross-sectional view schematically showing a configuration of a negative electrode active material 1000 of Embodiment 1. FIG. 1B is a cross-sectional view schematically showing a configuration of a porous silicon particle 100 of Embodiment 1.

The negative electrode active material 1000 includes the porous silicon particle 100 and a solid electrolyte. The solid electrolyte included in the negative electrode active material 1000 is referred to as a first solid electrolyte 101. The porous silicon particle 100 has a plurality of pores 102. The first solid electrolyte 101 has a shape of a thin film that covers at least a part of an inner surface of each of the pores 102.

The porous silicon particle 100 can function as an active material. Since the first solid electrolyte 101 covers, in the shape of a thin film, at least a part of the inner surface of each of the pores 102 of the porous silicon particle 100, a lot of interfaces, that is, a lot of ion conduction paths, are formed between the porous silicon particle 100 and the first solid electrolyte 101. This makes it possible to transport lithium ions even into the pores 102, enhancing the ionic conductivity of the negative electrode active material 1000. Moreover, charge and discharge reactions can be made smoothly at a lot of these interfaces, reducing occurrence of local expansion and shrinkage of the negative electrode active material 1000. Thereby, the charge-discharge cycle characteristics of a battery are improved.

In the present disclosure, the term “at least a part” means a part or all of the corresponding region.

The thin film of the first solid electrolyte 101 has an average thickness of less than 30 nm. In the negative electrode active material 1000, the thin film of the first solid electrolyte 101 is sufficiently thin, allowing the pores 102 to be maintained sufficiently in the negative electrode active material 1000. Thereby, a space for expansion at the time of charging can be ensured sufficiently in the negative electrode active material 1000. In addition, when the thin film of the first solid electrolyte 101 has an average thickness of less than 30 nm, it is possible to keep appropriately the total amount of the solid electrolyte with respect to the entire negative electrode. This makes it possible to reduce a decrease in weight energy density of the negative electrode.

Another material, such as a conductive additive, may be present inside each of the pores 102. When a space is ensured because the first solid electrolyte 101 does not fill the whole of each of the pores 102, the space functions as the “space for expansion at the time of charging.”

The first solid electrolyte 101 reaches a central part of the porous silicon particle 100. For example, when a cross-section of the negative electrode active material 1000 selected arbitrarily from a powder of the negative electrode active material 1000 is observed using a scanning electron microscope (SEM) or a transmission electron microscope (TEM), the first solid electrolyte 101 is present at a central part of the cross-section. The term “central part of a cross-section” is defined as, for example, a region within a distance of r/3 from the center of a circle having a minimum area that surrounds a cross-section of a particle of the negative electrode active material 1000. The symbol “r” is a radius of the circle. For the cross-section observation, the negative electrode active material 1000 that is relatively large and has a shape close to a spherical shape can be selected.

The average thickness of the thin film of the first solid electrolyte 101 may be 25 nm or less or 10 nm or less. The above configuration makes it possible to sufficiently provide interfaces for ion transport even inside the porous silicon particle while ensuring the space for expansion at the time of charging in the negative electrode active material 1000. As a result, the charge-discharge cycle characteristics of a battery can be further improved. The lower limit of the average thickness of the thin film of the first solid electrolyte 101 is not particularly limited. The lower limit of the average thickness of the thin film of the first solid electrolyte 101 may be 3 nm or 4 nm.

In the present disclosure, the term “shape of a thin film” means a state in which the first solid electrolyte 101 is formed thinly.

The average thickness of the thin film of the first solid electrolyte 101 can be determined in the following manner, for example. Specifically, the negative electrode active material 1000 is first processed to expose a cross-section of the negative electrode active material 1000. The negative electrode active material 1000 can be processed, for example, using a Cross Section Polisher (registered trademark). A smooth cross-section of the negative electrode active material 1000 can be formed using a Cross Section Polisher. Then, the cross-section of the negative electrode active material 1000 is observed using a scanning electron microscope (SEM) or a transmission electron microscope (TEM). An SEM image or TEM image of the cross-section of the negative electrode active material 1000 can be obtained thereby. Next, the porous silicon particle 100, the first solid electrolyte 101, and the pores 102 are recognized in the SEM image or TEM image. These may be recognized on the basis of contrast of the image or on the basis of the results of element analysis such as energy dispersive X-ray spectroscopy (EDS). Next, the thickness of the thin film of the first solid electrolyte 101 is measured at arbitrarily selected ten points in the SEM image or TEM image. These measurement values are averaged to determine the average thickness of the thin film of the first solid electrolyte 101.

The first solid electrolyte 101 constituting the thin film has its own shape that is not particularly limited. The thin film of the first solid electrolyte 101 may be composed of an accumulation of fine particles, in a shape of a plate, a needle, a sphere, an ellipsoid, or the like, of the first solid electrolyte 101. In an in-plane direction of the first solid electrolyte 101 having the shape of a thin film, ionic conduction tends to be promoted. The fact that the first solid electrolyte 101 has the shape of a thin film can be confirmed by observing the SEM image or TEM image of the cross-section of the negative electrode active material 1000.

When the thin film of the first solid electrolyte 101 is formed of an accumulation of fine particles of the first solid electrolyte 101, the fine particles of the first solid electrolyte 101 may have a median size of 1 nm or more and 20 nm or less, or a median size of 1 nm or more and 5 nm or less.

The term “median size” commonly means a particle size at 50% in a volume-based cumulative particle size distribution. The volume-based particle size distribution is measured, for example, using a laser diffraction measurement apparatus.

The thin film of the first solid electrolyte 101 may cover or does not need to cover uniformly the inner surface of each of the pores 102 of the porous silicon particle 100. That is, the inner surface of each of the pores 102 of the porous silicon particle 100 may have a portion where the first solid electrolyte 101 is absent. When the thin film of the first solid electrolyte 101 covers uniformly the inner surface of each of the pores 102, the ionic conductivity of the negative electrode active material 1000 is further enhanced.

The first solid electrolyte 101 may cover, not only in the shape of a thin film but also in a shape other than the shape of a thin film, at least a part of the inner surface of each of the pores 102 of the porous silicon particle 100. The shape other than the shape of a thin film is a layer shape or a porous shape, for example. The thin film or the layer of the first solid electrolyte 101 may have a porous structure.

The first solid electrolyte 101 may cover, in the shape of a thin film, not only the inner surface of each of the pores 102 of the porous silicon particle 100 but also at least a part of an outer surface of the porous silicon particle 100. The above configuration allows even more interfaces to be formed between the porous silicon particle 100 and the first solid electrolyte 101. This can further enhance the ionic conductivity of the negative electrode active material 1000.

The thin film of the first solid electrolyte 101 may cover or does not need to cover uniformly the outer surface of the porous silicon particle 100. That is, the outer surface of the porous silicon particle 100 may have a portion where the first solid electrolyte 101 is absent. When the thin film of the first solid electrolyte 101 covers uniformly the outer surface of the porous silicon particle 100, the ionic conductivity of the negative electrode active material 1000 is further enhanced.

The first solid electrolyte 101 may cover, not only in the shape of a thin film but also in the shape other than the shape of a thin film, at least a part of the outer surface of the porous silicon particle 100.

The porous silicon particle 100 may include silicon as a main component, and, for example, may substantially consist of silicon. In the present disclosure, the term “main component” means a component whose content is highest in the porous silicon particle 100 on a mass basis. The phrase “substantially consist of silicon” means other components that alter essential characteristics of the material are excluded. However, the porous silicon particle 100 may include impurities other than silicon.

In the porous silicon particle 100, the plurality of pores 102 may be arranged three-dimensionally and continuously. At least one of the plurality of pores 102 may penetrate the porous silicon particle 100. As described above, the porous silicon particle 100 may have a so-called three-dimensional network structure. When the porous silicon particle 100 has a three-dimensional network structure, lithium ions can be transported further into the pores 102. This enhances the ionic conductivity of the negative electrode active material 1000.

The porous silicon particle 100 may be a secondary particle including a plurality of primary particles aggregated. The above configuration makes it possible to produce easily the porous silicon particle 100 having the plurality of pores 102 inside thereof by using silicon fine particles.

When the porous silicon particle 100 is the secondary particle, the plurality of primary particles may be in contact with each other.

The primary particles each have a shape that is not particularly limited. The shape of each of the primary particles may be, for example, a shape of a plate, a flake, a needle, a sphere, an ellipsoid, or the like.

For example, the pores 102 each may be arranged between two of the primary particles. The plurality of pores 102 may be arranged three-dimensionally and continuously. At least one of the plurality of pores 102 may penetrate the porous silicon particle 100. As described above, when the porous silicon particle 100 is the secondary particle, the porous silicon particle 100 can have a three-dimensional network structure.

The primary particles each may include silicon as a main component, and, for example, may substantially consist of silicon. However, the primary particles each may include impurities other than silicon.

Some of the pores 102 may be filled partially with the first solid electrolyte 101.

The pores 102 of the porous silicon particle 100 have a shortest diameter that is 1 nm or more and 200 nm or less, for example. When the shortest diameter is 1 nm or more, the first solid electrolyte 101 can be introduced into the pores 102 easily. When the shortest diameter is 200 nm or less, it is possible for the pores 102 to allow the porous silicon particle 100 to have a sufficient space for expansion.

The lower limit of the shortest diameter of the pores 102 may be 10 nm. The upper limit of the shortest diameter of the pores 102 may be 100 nm.

The shortest diameter of the pores 102 can be determined in the following manner, for example. First, an SEM image or TEM image of a cross-section of the negative electrode active material 1000 is obtained in the same manner as mentioned above. In the SEM image or TEM image, the porous silicon particle 100, the first solid electrolyte 101, and the pores 102 are recognized. Then, the center of gravity of one of the pores 102 is determined in the SEM image or TEM image. The shortest diameter of diameters of the pore 102 can be considered the shortest diameter of the pores 102, the diameters passing through the center of gravity of the pore 102. In the SEM image or TEM image of the cross-section of the negative electrode active material 1000, a diameter of a circle having a minimum area that surrounds the pore 102 may be considered the shortest diameter of the pore 102.

The pores 102 may have an average shortest diameter of 1 nm or more and 200 nm or less. The average shortest diameter of the pores 102 can be determined by determining the shortest diameters of an arbitrary number (e.g., 5) of the pores 102 in the SEM image or TEM image of the cross-section of the negative electrode active material 1000, and then averaging these values.

When the SEM image or TEM image shows a plurality of the pores 102, the shortest diameter that is the greatest of the respective shortest diameters of the plurality of pores 102 shown may be 1 nm or more and 200 nm or less.

The fact that the first solid electrolyte 101 covers, in the shape of a thin film, at least a part of the inner surface of each of the pores 102 can be confirmed by the SEM observation or TEM observation of the cross-section of the negative electrode active material 1000 mentioned above. In addition, use of a gas adsorption method using nitrogen or a mercury intrusion method makes it possible to confirm that the first solid electrolyte 101 is present inside the pores 102 on the basis of a pore diameter of the porous silicon particle 100 and a pore diameter of the negative electrode active material 1000.

The gas adsorption method using a nitrogen gas makes it possible to obtain a pore distribution in which the volume of the pores is specified for each diameter D by converting, by a BJH (Barrett-Joyner-Halenda) method, adsorption isotherm data obtained from a specimen having the pores. The pore distribution is, for example, a graph showing a relation between the pore diameter D and a log differential pore volume.

In the mercury intrusion method, pressurized mercury is first injected into a specimen having pores. A pore distribution can be determined from a relation between the pressure applied to the mercury and the amount of the mercury injected into the specimen. Specifically, for the specimen, a diameter D of a pore into which the mercury was injected can be determined by the following relational expression (I). In the relational expression (I), the symbol γ represents a surface tension of the mercury. The symbol θ represents a contact angle between the mercury and a wall surface of the specimen. The symbol P represents a pressure applied to the mercury.

D=−4γ cos θ÷P (I)

The pressure P is changed in stages, and the amount of the injected mercury is measured for each stage. The amount of the injected mercury can be considered a cumulative value of the volumes of the pores having a diameter up to the diameter D, the diameter D corresponding to a particular pressure P. A pore distribution in which the volume of the pores is specified for each diameter D can be obtained thereby. The pore distribution is, for example, a graph showing a relation between the pore diameter D and a log differential pore volume.

In the present embodiment, pore distributions can be obtained, for example, respectively for the negative electrode active material 1000 in which the first solid electrolyte 101 is present inside the pores 102 and the porous silicon particle 100 in which the first solid electrolyte 101 is absent inside the pores 102 by the BJH method that is a gas adsorption measurement using nitrogen or the mercury intrusion method. As the porous silicon particle 100 in which the first solid electrolyte 101 is absent inside the pores 102, the porous silicon particle 100 in which the first solid electrolyte 101 has not been introduced into the pores 102 can be used. The porous silicon particle 100 obtained by removing the first solid electrolyte 101 from the negative electrode active material 1000 may also be used. The first solid electrolyte 101 can be removed from the negative electrode active material 1000 using a solvent, etc., for example.

On the basis of the pore distribution of the negative electrode active material 1000 and that of the porous silicon particle 100, it is possible to confirm that the first solid electrolyte 101 is present inside the pores 102 in the negative electrode active material 1000. Specifically, for example, the log differential pore volume at a particular diameter D is determined for the pore distribution of each of the negative electrode active material 1000 and the porous silicon particle 100. When the log differential pore volume of the negative electrode active material 1000 is smaller at the particular diameter D than the log differential pore volume of the porous silicon particle 100, it can be understood that the first solid electrolyte 101 is present inside the pores 102 of the porous silicon particle 100. Additionally, when the diameter D at a peak in the pore distribution of the negative electrode active material 1000 is smaller than the diameter D at a peak in the pore distribution of the porous silicon particle 100, it can be understood that the first solid electrolyte 101 is present inside the pores 102 of the porous silicon particle 100.

When the porous silicon particle 100 has the plurality of pores 102, an average pore diameter S, determined by the BJH method that is a gas adsorption measurement using nitrogen or the mercury intrusion method, of the porous silicon particle 100 is not particularly limited. The average pore diameter S, determined by the BJH method that is a gas adsorption measurement using nitrogen or the mercury intrusion method, of the porous silicon particle 100 is, for example, 1 nm or more and 200 nm or less. The lower limit of the average pore diameter S may be 10 nm. The upper limit of the average pore diameter S may be 100 nm.

The average pore diameter S of the porous silicon particle 100 can be determined in the following manner, for example. First, a pore distribution showing a relation between the pore diameter D and the log differential pore volume is obtained for the porous silicon particle 100 in which the first solid electrolyte 101 is absent inside the pores 102 by the BJH method that is a gas adsorption measurement using nitrogen or the mercury intrusion method mentioned above. Next, a peak in the pore distribution of the porous silicon particle 100 is determined. The diameter D at the peak in the pore distribution can be considered the average pore diameter S. The diameter D at the peak in the pore distribution corresponds to a mode diameter of the pores.

The porous silicon particle 100 has a shape that is not particularly limited. The shape of the porous silicon particle 100 is, for example, a shape of a sphere or an ellipsoid. The shape of the porous silicon particle 100 may be a shape of a needle, a plate, or the like. When the porous silicon particle 100 is the secondary particle, the porous silicon particle 100 may have, on a surface thereof, a rugged shape caused by the primary particles in the shape of a plate or the like.

The porous silicon particle 100 has a median size that is, for example, but not particularly limited to, 50 nm or more and 30 μm or less. The porous silicon particle 100 having a median size of 50 nm or more can be easily handled and is thus suitable for producing the negative electrode active material 1000. The first solid electrolyte 101 can be easily introduced into the pores 102 of the porous silicon particle 100 having a median size of 30 μm or less. The porous silicon particle 100 may have a median size of 200 nm or more and 10 μm or less.

In the present description, ratios may be expressed in percentage.

A ratio of a pore volume of the negative electrode active material 1000 to a pore volume of the porous silicon particle 100 may be 55% or more and less than 99%. The above configuration makes it possible to sufficiently provide interfaces for ion transport even inside the porous silicon particle 100 while ensuring the space for expansion at the time of charging in the negative electrode active material 1000. As a result, the charge-discharge cycle characteristics of a battery can be further improved.

The ratio of the pore volume of the negative electrode active material 1000 to the pore volume of the porous silicon particle 100 may be 70% or more and 98% or less, or 80% or more and 95% or less.

In the present disclosure, the term “pore volume” means an estimated pore volume in a pore distribution obtained by the BJH method that is a gas adsorption measurement using nitrogen or the mercury intrusion method mentioned above.

The pore volume of each of the porous silicon particle 100 and the negative electrode active material 1000 can be determined by the pore distribution obtained by the BJH method that is a gas adsorption measurement using nitrogen or the mercury intrusion method mentioned above.

The pore volume of the porous silicon particle 100 is not particularly limited. The pore volume of the porous silicon particle 100 is 5×10⁻⁸ m³/g or more, for example. When the pore volume is 5×10⁻⁸ m³/g or more, the inner surface of each of the pores 102 can be coated with a sufficient amount of the first solid electrolyte 101. The larger pore volume the porous silicon particle 100 has, the larger area of the inner surface of each of the pores 102 the first solid electrolyte 101 can coat. The upper limit of the pore volume of the porous silicon particle 100 is not particularly limited. The upper limit of the pore volume of the porous silicon particle 100 may be 5×10⁻⁶ m³/g.

The pore volume of the negative electrode active material 1000 is not particularly limited. The pore volume of the negative electrode active material 1000 is 4×10⁻⁸ m³/g or more, for example. The upper limit of the pore volume of the negative electrode active material 1000 is not particularly limited. The upper limit of the pore volume of the negative electrode active material 1000 may be 4×10⁻⁶ m³/g.

A ratio of a specific surface area of the negative electrode active material 1000 to a specific surface area of the porous silicon particle 100 may be 55% or more and less than 99%. The above configuration makes it possible to sufficiently provide interfaces for ion transport even inside the porous silicon particle 100 while ensuring the space for expansion at the time of charging in the negative electrode active material 1000. Moreover, since the specific surface area of the negative electrode active material 1000 is smaller than that of the porous silicon particle 100, the negative electrode active material 1000 is more likely to be brought into contact with another solid electrolyte in the negative electrode than when only the porous silicon particle 100 is used as the negative electrode active material. As a result, the charge-discharge cycle characteristics of a battery can be further improved.

The ratio of the specific surface area of the negative electrode active material 1000 to the specific surface area of the porous silicon particle 100 may be 60% or more and 95% or less, or 70% or more and 90% or less.

The specific surface area of each of the porous silicon particle 100 and the negative electrode active material 1000 can be determined, for example, by converting, by a BET (Brunauer-Emmett-Teller) method, adsorption isotherm data obtained by the gas adsorption method using nitrogen.

The specific surface area of the porous silicon particle 100 is not particularly limited. The specific surface area of the porous silicon particle 100 is 10 m²/g or more, for example. When the specific surface area is 10 m²/g or more, the inner surface of each of the pores 102 can be coated with a sufficient amount of the first solid electrolyte 101. The larger specific surface area the porous silicon particle 100 has, the larger area of the inner surface of each of the pores 102 the first solid electrolyte 101 can coat. The upper limit of the specific surface area of the porous silicon particle 100 is not particularly limited. The upper limit of the specific surface area of the porous silicon particle 100 may be 500 m²/g.

The specific surface area of the negative electrode active material 1000 is not particularly limited. The specific surface area of the negative electrode active material 1000 is 10 m²/g or more, for example. The upper limit of the specific surface area of the negative electrode active material 1000 is not particularly limited. The upper limit of the specific surface area of the negative electrode active material 1000 may be 500 m²/g.

The porous silicon particle 100 has a porosity that is not particularly limited. The porosity of the porous silicon particle 100 may be 5% or more, for example. When the porosity is 5% or more, the inner surface of each of the pores 102 can be coated with a sufficient amount of the first solid electrolyte 101. The upper limit of the porosity of the porous silicon particle 100 is not particularly limited. The upper limit of the porosity of the porous silicon particle 100 is 50%, for example. When the porosity is 50% or less, the porous silicon particle 100 tends to have a sufficiently high strength.

In the present disclosure, the term “porosity of the porous silicon particle 100” means a ratio of the total volume of the plurality of pores 102 to the volume of the porous silicon particle 100 including the plurality of pores 102.

The porosity of the porous silicon particle 100 can be measured, for example, by the mercury intrusion method. The porosity of the porous silicon particle 100 can also be calculated from the pore volume obtained by the BJH method that is a gas adsorption measurement using nitrogen.

A ratio of a volume of the first solid electrolyte 101 to a volume of the porous silicon particle 100 may be 0.5% or more and less than 15%. The above configuration makes it possible to enhance the ionic conductivity while reducing a decrease in capacity density of the negative electrode active material 1000.

The ratio of the volume of the first solid electrolyte 101 to the volume of the porous silicon particle 100 may be 1% or more and 12% or less, or 2% or more and 7% or less.

The ratio of the volume of the first solid electrolyte 101 to the volume of the porous silicon particle 100 can be calculated from the amount of materials used, and can also be calculated in the following manner. The first solid electrolyte 101 is extracted from the negative electrode active material 1000 using a solvent (a polar solvent, such as ethanol, for example) that can dissolve the first solid electrolyte 101. Thereby, the first solid electrolyte 101 is removed from the negative electrode active material 1000, so that only the porous silicon particle 100 can be taken out. The porous silicon particle 100 taken out is dried and a mass thereof is measured. A mass of the first solid electrolyte 101 can be determined by subtracting the mass of the porous silicon particle 100 from a mass of the negative electrode active material 1000. The mass of the first solid electrolyte 101 can be also determined by performing, using an ICP analytical method or the like, a quantitative analysis on the solvent that has extracted the first solid electrolyte 101. The volume of the porous silicon particle 100 can be calculated from the mass of the porous silicon particle 100 and a true density of the porous silicon particle 100. The volume of the porous silicon particle 100 may be determined by subtracting the volume of the first solid electrolyte 101 from a volume of the negative electrode active material 1000. The volume of the negative electrode active material 1000 can be calculated from the mass of the negative electrode active material 1000 and a true density of the negative electrode active material 1000. The volume of the first solid electrolyte 101 can be calculated from the mass of the first solid electrolyte 101 and a true density of the first solid electrolyte 101. The true density of the porous silicon particle 100, the true density of the first solid electrolyte 101, and the true density of the negative electrode active material 1000 can be measured by a pyknometer method, for example.

When the negative electrode active material 1000 is included in an electrode, the negative electrode active material 1000 can be taken out in the following manner, for example. An electrode including the negative electrode active material 1000 is dispersed in a solvent that does not dissolve the first solid electrolyte 101. The obtained dispersion medium is subjected to a centrifuge method so that only the negative electrode active material 1000 can be taken out because of difference in particle density.

The first solid electrolyte 101 has, for example, lithium ion conductivity. The first solid electrolyte 101 includes, for example, at least one selected from the group consisting of an inorganic solid electrolyte and an organic solid electrolyte.

The first solid electrolyte 101 may include a sulfide solid electrolyte. Since the sulfide solid electrolyte has high reduction stability, the sulfide solid electrolyte is suitable for being combined with the porous silicon particle 100 being a low-electric potential negative electrode material.

The first solid electrolyte 101 may include lithium, phosphorus, sulfur, and halogen. The above configuration makes it possible to enhance the ionic conductivity of the negative electrode active material 1000.

The first solid electrolyte 101 may be represented by the following composition formula (1), for example.

Li_{α}PS_{β}X_{γ} Formula (1)

In the formula (1), α, β, and γ satisfy 5.5≤α≤6.5, 4.5≤β≤5.5, and 0.5≤γ≤1.5. The symbol X includes at least one selected from the group consisting of F, Cl, Br, and I. The symbol X may include at least one selected from the group consisting of Cl and Br. The symbol X may include Cl. The first solid electrolyte 101 may be Li₆PS₅X.

The solid electrolyte represented by the composition formula (1) has, for example, an argyrodite crystal structure. That is, the first solid electrolyte 101 may have an argyrodite crystal structure. The negative electrode active material 1000 including such a first solid electrolyte 101 tends to have high ion conductivity.

Examples of the sulfide solid electrolyte other than the solid electrolyte represented by the composition formula (1) include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂. LiX, Li₂O, MO_{q}, LiₚMO_{q}, or the like may be added thereto. Here, the element X in “LiX” is at least one selected from the group consisting of F, Cl, Br, and I. The element M in “MO_{q}” and “LiₚMO_{q}” is at least one selected from the group consisting of P, Si, Ge, B, Al, Ga, In, Fe, and Zn. The symbols p and q in “MO_{q}” and “LiₚMO_{q}” are each an independent natural number.

The first solid electrolyte 101 may include at least one selected from the group consisting of an oxide solid electrolyte, a polymer solid electrolyte, and a complex hydride solid electrolyte.

As the oxide solid electrolyte can be used, for example, a NASICON solid electrolyte typified by LiTi₂(PO₄)₃ and element-substituted substances thereof; a (LaLi)TiO₃-based perovskite solid electrolyte; a LISICON solid electrolyte typified by LiI₄ZnGe₄O₁₆, Li₄SiO₄, and LiGeO₄ and element-substituted substances thereof; a garnet solid electrolyte typified by Li₇La₃Zr₂O₁₂ and element-substituted substances thereof; Li₃N and H-substituted substances thereof; Li₃PO₄ and N-substituted substances thereof; or a glass or glass ceramic including a base material that includes a Li—B—O compound such as LiBO₂ or Li₃BO₃ and to which a material such as Li₂SO₄, Li₂CO₃, or the like has been added.

For example, a compound of a polymer compound and a lithium salt can be used as the polymer solid electrolyte. The polymer compound may have an ethylene oxide structure. The polymer compound having an ethylene oxide structure can contain a large amount of a lithium salt, and therefore, the ionic conductivity can be further increased. LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), LiC(SO₂CF₃)₃, or the like can be used as the lithium salt. As the lithium salt, one lithium salt selected from these may be used alone, or a mixture of two or more lithium salts selected from these may be used.

For example, LiBH₄—LiI or LiBH₄—P₂S₅ can be used as the complex hydride solid electrolyte.

The negative electrode active material 1000 may further include or does not need to include a solid electrolyte other than the first solid electrolyte 101. The solid electrolyte other than the first solid electrolyte 101 may be in contact with the outer surface of the porous silicon particle 100. The outer surface of the negative electrode active material 1000 may be coated with the solid electrolyte other than the first solid electrolyte 101.

### <Method for Producing Negative Electrode Active Material>

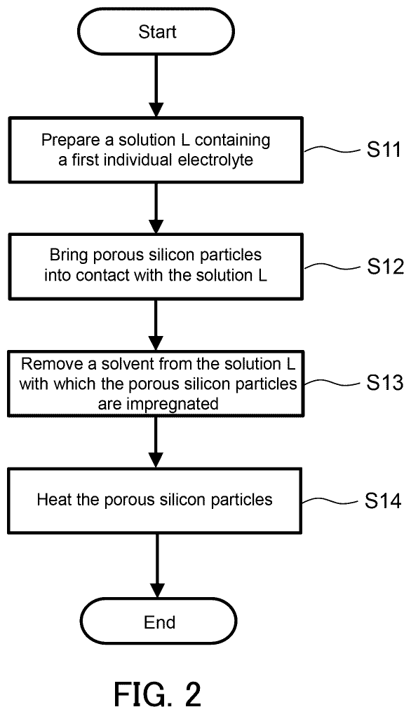

Next, a method for producing the above-mentioned negative electrode active material 1000 will be described. The negative electrode active material 1000 can be produced in the following manner, for example. FIG. 2 is a flow chart showing the method for producing the negative electrode active material 1000 of Embodiment 1.

The porous silicon particle 100 having the plurality of pores 102 is prepared. The porous silicon particle 100 may be a secondary particle formed from a plurality of primary particles aggregated.

A precursor powder of the first solid electrolyte 101 is prepared. The precursor powder of the first solid electrolyte 101 is a precursor powder including lithium, phosphorus, sulfur, and halogen. The precursor powder including lithium, phosphorus, sulfur, and halogen may include, for example, a precursor powder including lithium and sulfur, a precursor powder including phosphorus and sulfur, and a precursor powder including lithium and halogen. Examples of the precursor powder including lithium and sulfur include Li₂S. Examples of the precursor powder including phosphorus and sulfur include P₂S₅. As the precursor powder including lithium and halogen, LiBr, LiCl, and LiI can be mentioned.

Next, a solution L containing the first solid electrolyte 101 is prepared (Step S11). Specifically, the above-mentioned precursor powders are weighed at a stoichiometric ratio and mixed. The obtained powder mixture is stirred with a solvent to obtain the solution L. A concentration of the precursor powder of the first solid electrolyte 101 in the solution L is, for example, but not particularly limited to, 1 mass % or more and 20 mass % or less.

Next, the porous silicon particle 100 is brought into contact with the solution L (Step S12). In the Step S12, the first solid electrolyte 101 is not generated in the solution L. In other words, the solution L does not include particles of the first solid electrolyte 101. Therefore, when the porous silicon particle 100 is brought into contact with the solution L, the solution L can easily permeate the pores 102 of the porous silicon particle 100. Specifically, the solution L easily permeates the pores 102 of the porous silicon particle 100 by capillary action. The solution L is thereby introduced into the pores 102.

The method for bringing the porous silicon particle 100 into contact with the solution L is not particularly limited. For example, the porous silicon particle 100 may be brought into contact with the solution L by kneading the porous silicon particle 100 and the solution L. When the porous silicon particle 100 is brought into contact with the solution L, a ratio of a volume of the precursor powder of the first solid electrolyte 101 to the total of the volume of the porous silicon particle 100 and the volume of the precursor powder of the first solid electrolyte 101 is, for example, but not particularly limited to, more than 0.1% and less than 15%.

Next, the solvent is removed from the solution L with which the porous silicon particle 100 is impregnated (Step S13). This causes deposition of the first solid electrolyte 101 inside the pores 102. The solvent is removed, for example, by volatilization of the solvent. In one example, the porous silicon particle 100 and the solution L may be kneaded to volatilize the solvent of the solution L. The solvent of the solution L having permeated the porous silicon particle 100 is less likely to be volatilized than the solvent of the solution L on the outside of the porous silicon particle 100. Therefore, the volatilization of the solvent contained in the solution L tends to condense the first solid electrolyte 101 inside the pores 102 of the porous silicon particle 100. After the volatilization of the solvent of the solution L, the first solid electrolyte 101 is unlikely to be deposited in a place other than the porous silicon particle 100 and is supported in the pores 102 by the porous silicon particle 100.

After the solvent is removed, the porous silicon particle 100 is heated (Step S14). This makes it possible to obtain the negative electrode active material 1000 in which the first solid electrolyte 101 is present, in the shape of a thin film, on at least a part of the inner surface of each of the pores 102 of the porous silicon particle 100. The thin film of the first solid electrolyte 101 can also be formed on at least a part of the outer surface of the porous silicon particle 100. The conditions of the heating treatment can be set as appropriate in accordance with, for example, the composition of the first solid electrolyte 101. The temperature of the heating treatment is, for example, but not particularly limited to, 100° C. or higher. The duration of the heating treatment is, for example, but not particularly limited to, 1 hour or more. The heating treatment may be performed under reduced pressure or under a vacuum atmosphere. The heating treatment tends to enhance the degree of crystallization of the first solid electrolyte 101.

The method for producing the negative electrode active material 1000 is not limited to the one shown in the flow chart of FIG. 2. For example, the negative electrode active material 1000 may be produced using the first solid electrolyte 101 instead of the precursor powder of the first solid electrolyte 101, and a dispersion solution of the first solid electrolyte 101 instead of the solution L.

The method for producing the porous silicon particle 100 having the plurality of pores 102 is not particularly limited. The porous silicon particle 100 can be produced, for example, by removing, through elution or the like, a metal other than silicon from a precursor composed of an alloy of silicon and a metal such as lithium, and then washing and drying the silicon.

### Embodiment 2

Hereinafter, Embodiment 2 will be described. The description overlapping that in Embodiment 1 will be omitted as appropriate.

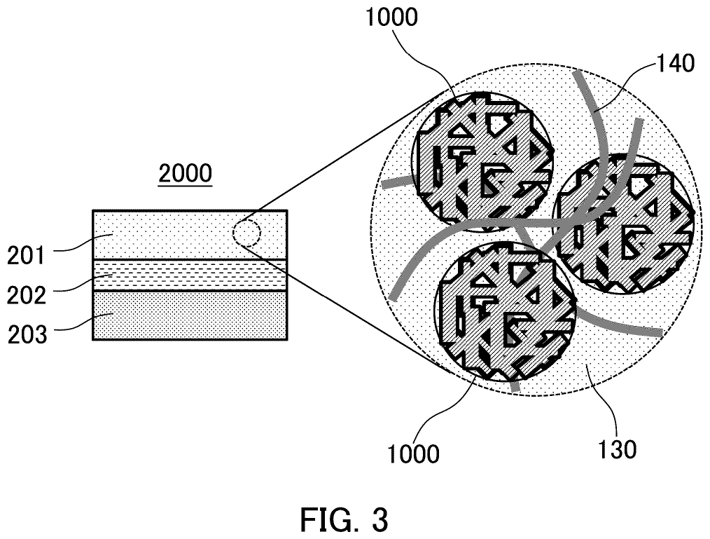

FIG. 3 is a cross-sectional view schematically showing a configuration of a battery 2000 of Embodiment 2.

The battery 2000 includes a negative electrode 201, a positive electrode 203, and an electrolyte layer 202 disposed between the negative electrode 201 and the positive electrode 203. The negative electrode 201 includes the negative electrode active material 1000 of Embodiment 1.

The above configuration makes it possible to improve the charge-discharge cycle characteristics of the battery 2000 because the negative electrode 201 includes the negative electrode active material 1000.

The negative electrode 201 includes, for example, a negative electrode active material layer including the negative electrode active material 1000, and a negative electrode current collector. The negative electrode active material layer is disposed between the negative electrode current collector and the electrolyte layer 202.

In producing the battery 2000, a negative electrode material including the negative electrode active material 1000 is compression-molded to produce the negative electrode active material layer in some cases. The porous silicon particle 100 included in the negative electrode active material 1000 has high hardness. Thus, the negative electrode active material 1000 is likely to maintain the pores 102 even after the compression molding. In other words, in the battery 2000 using the negative electrode active material 1000, the particle shape of the negative electrode active material 1000 is maintained in the negative electrode 201.

It is possible to understand the structure of the negative electrode active material 1000 in the negative electrode 201 by determining a shortest diameter of the pores 102 of the negative electrode active material 1000 included in the negative electrode 201. The shortest diameter of the pores 102 of the negative electrode active material 1000 included in the negative electrode 201 can be determined in the following manner, for example. First, the negative electrode 201 is processed to expose a cross-section of the negative electrode 201. Next, an SEM image or TEM image of the cross-section of the negative electrode 201 is obtained. Next, in the SEM image or TEM image, the negative electrode active material 1000 is recognized, and in addition the porous silicon particle 100, the first solid electrolyte 101, and the pores 102 are recognized. Then, the center of gravity of one of the pores 102 is determined in the SEM image or TEM image. The shortest diameter of diameters of the pore 102 can be considered the shortest diameter of the pores 102, the diameters passing through the center of gravity of the pore 102. In the SEM image or TEM image of the cross-section of the negative electrode 201, a diameter of a circle having a minimum area that surrounds the pore 102 may be considered the shortest diameter of the pore 102.

An average shortest diameter of the pores 102 of the negative electrode active material 1000 included in the negative electrode 201 can be determined by determining the shortest diameters of an arbitrary number (e.g., 5) of the pores 102 in the SEM image or TEM image of the cross-section of the negative electrode 201, and then averaging these values.

The negative electrode 201 may further include a solid electrolyte. The solid electrolyte that may be included in the negative electrode 201 is referred to as a second solid electrolyte 130. The second solid electrolyte 130 fills, for example, a space between a plurality of the negative electrode active materials 1000 in the negative electrode 201. The second solid electrolyte 130 may have a shape of a particle. An ion conduction path may be formed by compressing and bonding a lot of particles of the second solid electrolyte 130.

The second solid electrolyte 130 may be or does not need to be in contact with the first solid electrolyte 101 included in the negative electrode active material 1000. When the second solid electrolyte 130 is in contact with the first solid electrolyte 101, ionic conduction into the negative electrode active material 1000 can efficiently occur.

The second solid electrolyte 130 has lithium ion conductivity. The second solid electrolyte 130 includes, for example, at least one selected from the group consisting of an inorganic solid electrolyte and an organic solid electrolyte. The second solid electrolyte 130 may include at least one selected from the group consisting of a sulfide solid electrolyte, an oxide solid electrolyte, a halide solid electrolyte, a polymer solid electrolyte, and a complex hydride solid electrolyte. As the sulfide solid electrolyte, the oxide solid electrolyte, the polymer solid electrolyte, and the complex hydride solid electrolyte, those described for the first solid electrolyte 101 in Embodiment 1 can be used. Specific examples of the halide solid electrolyte will be described later in the description of the electrolyte layer 202.

The second solid electrolyte 130 is desirably made of a soft material to achieve a favorable dispersion state with the negative electrode active material 1000. From this perspective, at least one selected from the group consisting of the sulfide solid electrolyte and the halide solid electrolyte is suitable as the second solid electrolyte 130.

The second solid electrolyte 130 may include a sulfide solid electrolyte.

The composition of the second solid electrolyte 130 may be the same as or different from that of the first solid electrolyte 101. In one example, the composition of the first solid electrolyte 101 may be adjusted so that the first solid electrolyte 101 will be easily introduced into the tiny pores 102 of the porous silicon particle 100. The composition of the second solid electrolyte 130 may be adjusted to have high ion conductivity.

The second solid electrolyte 130 has a shape that is not particularly limited. The shape of the second solid electrolyte 130 may be a shape of a needle, a sphere, an ellipsoid, a flake, or the like. The second solid electrolyte 130 may have a shape of a particle.

When the second solid electrolyte 130 has the shape of a particle (e.g., a sphere), the second solid electrolyte 130 may have a median size of 0.3 μm or more and 100 μm or less. When the second solid electrolyte 130 has a median size of 0.3 μm or more, a contact interface between the particles of the second solid electrolyte 130 is not increased too much and an increase in the ionic resistance inside the negative electrode 201 can be reduced. This allows the battery 2000 to operate at a high power.

When the second solid electrolyte 130 has a median size of 100 μm or less, the negative electrode active material 1000 and the second solid electrolyte 130 are likely to be in a favorable dispersion state in the negative electrode 201. This makes it easy to increase the capacity of the battery 2000.

The median size of the second solid electrolyte 130 may be smaller than that of the negative electrode active material 1000. In this case, the negative electrode active material 1000 and the second solid electrolyte 130 can be in a favorable dispersion state in the negative electrode 201.

The negative electrode 201 may further include an additional active material other than the negative electrode active material 1000. The additional active material has a shape that is not particularly limited. The shape of the additional active material may be a shape of a needle, a sphere, an ellipsoid, or the like. The additional active material may have a shape of a particle.

The additional active material may have a median size of 0.1 μm or more and 100 μm or less.

When the additional active material has a median size of 0.1 μm or more, the additional active material and the second solid electrolyte 130 are likely to be in a favorable dispersion state in the negative electrode 201. This improves the charge characteristics of the battery 2000.

When the additional active material has a median size of 100 μm or less, the diffusion rate of lithium in the active material is sufficiently ensured. This allows the battery 2000 to operate at a high power.

The median size of the additional active material may be larger than that of the second solid electrolyte 130. In this case, the additional active material and the second solid electrolyte 130 can be in a favorable dispersion state.

The additional active material includes a material having properties of occluding and releasing metal ions (e.g., lithium ions). A metal material, a carbon material, an oxide, a nitride, a tin compound, a silicon compound, or the like can be used as the additional active material. The metal material may be an elemental metal or an alloy. Examples of the metal material include lithium metal and a lithium alloy. Examples of the carbon material include natural graphite, coke, semi-graphitized carbon, carbon fibers, spherical carbon, artificial graphite, and amorphous carbon. In terms of the capacity density, silicon (Si), tin (Sn), a silicon compound, or a tin compound can be suitably used. The additional active material may include a single active material or a plurality of active materials having different compositions.

The negative electrode active material 1000 and the second solid electrolyte 130 may be in contact with each other as shown in FIG. 3. The negative electrode 201 may include a plurality of the negative electrode active materials 1000 and a plurality of the second solid electrolytes 130.

In the negative electrode 201, the amount of the second solid electrolyte 130 may be equal to or different from the amount of the negative electrode active material 1000.

When the total amount of the negative electrode 201 is 100 mass %, the amount of the negative electrode active material 1000 may be 40 mass % or more and 90 mass % or less, or 40 mass % or more and 80 mass % or less. The negative electrode active material 1000 and the second solid electrolyte 130 are likely to be in a favorable dispersion state in the negative electrode 201 by appropriately adjusting the amount of the negative electrode active material 1000.

For a mass ratio “w1:100−w1” between the active material and the second solid electrolyte 130 in the negative electrode 201, 40≤w1≤90 may be satisfied, or 40≤w1≤80 may be satisfied. When 40≤w1 is satisfied, the battery 2000 has a sufficient energy density. When w1≤90 is satisfied, the battery 2000 can operate at a high power. The term “active material” means that not only the negative electrode active material 1000 but also an additional active material other than the negative electrode active material 1000 is included.

The negative electrode 201 may have a thickness of 10 μm or more and 500 μm or less. When the negative electrode 201 has a thickness of 10 μm or more, the battery 2000 has a sufficient energy density. When the negative electrode 201 has a thickness of 500 μm or less, the battery 2000 can operate at a high power.

The electrolyte layer 202 is a layer including an electrolyte. The electrolyte is a solid electrolyte, for example. That is, the electrolyte layer 202 may be a solid electrolyte layer.

The solid electrolyte that can be included in the electrolyte layer 202 is referred to as a third solid electrolyte. The third solid electrolyte may include at least one selected from the group consisting of a sulfide solid electrolyte, an oxide solid electrolyte, a halide solid electrolyte, a polymer solid electrolyte, and a complex hydride solid electrolyte. As the sulfide solid electrolyte, the oxide solid electrolyte, the polymer solid electrolyte, and the complex hydride solid electrolyte, those described for the first solid electrolyte 101 in Embodiment 1 can be used.

The third solid electrolyte may include a sulfide solid electrolyte.

The third solid electrolyte may include at least one selected from the group consisting of an oxide solid electrolyte, a polymer solid electrolyte, and a complex hydride solid electrolyte.

The third solid electrolyte may include a halide solid electrolyte.

The halide solid electrolyte is represented, for example, by the following composition formula (2).

Li_{α}M_{β}X_{γ} Formula (2)

In the composition formula (2), α, β, and γ are each independently a value greater than 0. The symbol M includes at least one selected from the group consisting of metalloid elements and metal elements other than Li. The symbol X includes at least one selected from the group consisting of F, Cl, Br, and I.

In the present disclosure, the term “metalloid elements” refers to B, Si, Ge, As, Sb, and Te. The term “metal elements” refers to all the elements included in Groups 1 to 12 of the periodic table, except for hydrogen, and all the elements included in Groups 13 to 16 of the periodic table, except for B, Si, Ge, As, Sb, Te, C, N, P, O, S, and Se. That is, the terms “metalloid elements” and “metal elements” each refer to a group of elements that can become cations when forming an inorganic compound with a halogen element.

Specifically, Li₃YX₆, Li₂MgX₄, Li₂FeX₄, Li(Al,Ga,In)X₄, Li₃(Al,Ga,In)X₆, or the like can be used as the halide solid electrolyte. In the present disclosure, when an element in a formula is expressed, for example, as “(Al, Ga, In)”, the expression “(Al, Ga, In)” represents at least one selected from the group of elements in the parentheses. That is, the expression “(Al, Ga, In)” is synonymous with the expression “at least one selected from the group consisting of Al, Ga, and In”. The same applies to other elements.

The halide solid electrolyte exhibits high ion conductivity. Therefore, the above configuration can enhance the power density of the battery 2000. The above configuration can also enhance the thermal stability of the battery 2000 and reduce generation of a harmful gas such as hydrogen sulfide.

In the composition formula (2), M may include Y (=yttrium). That is, the halide solid electrolyte included in the electrolyte layer 202 may include Y as a metal element. The above configuration can further enhance the ionic conductivity of the halide solid electrolyte.

The halide solid electrolyte including Y may be a compound represented by the following composition formula (3).

LiₐMe_{b}Y_{c}X1₆ Formula (3)

In the composition formula (3), a+mb+3c=6 and c>0 are satisfied. The symbol Me includes at least one selected from the group consisting of metalloid elements and metal elements other than Li and Y The symbol m is the valence of the element Me. The symbol X1 includes at least one selected from the group consisting of F, Cl, Br, and I. The above configuration can further enhance the ionic conductivity of the halide solid electrolyte. This can further enhance the power density of the battery 2000.

The symbol Me may include, for example, at least one selected from the group consisting of Mg, Ca, Sr, Ba, Zn, Sc, Al, Ga, Bi, Zr, Hf, Ti, Sn, Ta, and Nb. The above configuration can further enhance the ionic conductivity of the halide solid electrolyte. This can further enhance the power density of the battery 2000.

As the halide solid electrolyte including Y can be used, specifically, Li₃YF₆, Li₃YCl₆, Li₃YBr₆, Li₃YI₆, Li₃YBrCl₅, Li₃YBr₃Cl₃, Li₃YBr₅Cl, Li₃YBr₅I, Li₃YBr₃₁₃, Li₃YBrI₅, Li₃YClI₅, Li₃YCl₃I₃, Li₃YCl₅I, Li₃YBr₂Cl₂I₂, Li₃YBrCl₄I, Li_{2.7}Y_{1.1}Cl₆, Li_{2.5}Y_{0.5}Zr_{0.5}Cl₆, Li_{2.5}Y_{0.3}Zr_{0.7}Cl₆, or the like. The above configuration can further enhance the power density of the battery 2000.

The electrolyte layer 202 may include only one solid electrolyte selected from the group consisting of the above solid electrolytes, or may include two or more solid electrolytes selected from the group consisting of the above solid electrolytes. The plurality of solid electrolytes has different compositions. For example, the electrolyte layer 202 may include the halide solid electrolyte and the sulfide solid electrolyte.

The electrolyte layer 202 may have a thickness of 1 μm or more and 300 μm or less. When the electrolyte layer 202 has a thickness of 1 μm or more, a short-circuit between the negative electrode 201 and the positive electrode 203 is less likely to happen. When the electrolyte layer 202 has a thickness of 300 μm or less, the battery 2000 can operate at a high power.

The positive electrode 203 contributes to operation of the battery 2000 as a counter electrode of the negative electrode 201.

The positive electrode 203 may include a material having properties of occluding and releasing metal ions (e.g., lithium ions). The positive electrode 203 includes, for example, a positive electrode active material. As the positive electrode active material, for example, a metal composite oxide, a transition metal fluoride, a polyanion material, a fluorinated polyanion material, a transition metal sulfide, a transition metal oxysulfide, or a transition metal oxynitride can be used. In particular, when a lithium-containing transition metal oxide is used as the positive electrode active material, it is possible to reduce the manufacturing cost and increase the average discharge voltage.

The positive electrode 203 includes, for example, a positive electrode active material layer including the positive electrode active material, and a positive electrode current collector. The positive electrode active material layer is disposed between the positive electrode current collector and the electrolyte layer 202.

The metal composite oxide selected as the positive electrode active material may include Li and at least one selected from the group consisting of Mn, Co, Ni, and Al. The above configuration can further enhance the energy density of the battery 2000. Examples of such a material include Li(Ni,Co,Al)O₂, Li(Ni,Co,Mn)O₂, and LiCoO₂. For example, the positive electrode active material may be Li(Ni,Co,Mn)O₂.

The positive electrode 203 may include an electrolyte, and may include, for example, a solid electrolyte. The above configuration can enhance the lithium ion conductivity inside the positive electrode 203 and allows the battery 2000 to operate at a high power. The materials described as examples of the third solid electrolyte in the electrolyte layer 202 may be used as the solid electrolyte included in the positive electrode 203.

The positive electrode active material has a shape that is not particularly limited. The shape of the positive electrode active material may be a shape of a needle, a sphere, an ellipsoid, or the like. The positive electrode active material may have a shape of a particle.

The positive electrode active material may have a median size of 0.1 μm or more and 100 μm or less. When the positive electrode active material has a median size of 0.1 μm or more, the positive electrode active material and the solid electrolyte can be in a favorable dispersion state in the positive electrode 203. This enhances the charging capacity of the battery 2000. When the positive electrode active material has a median size of 100 μm or less, the diffusion rate of lithium in the positive electrode active material is sufficiently ensured. This allows the battery 2000 to operate at a high power.

The median size of the positive electrode active material may be larger than that of the solid electrolyte included in the positive electrode 203. In this case, the positive electrode active material and the solid electrolyte can be in a favorable dispersion state in the positive electrode 203.

For a mass ratio “w2:100−w2” between the positive electrode active material and the solid electrolyte included in the positive electrode 203, 40≤w2≤90 may be satisfied. When 40≤w2 is satisfied, the battery 2000 has a sufficient energy density. When w2≤90 is satisfied, the battery 2000 can operate at a high power.

The positive electrode 203 may have a thickness of 10 μm or more and 500 μm or less. When the positive electrode 203 has a thickness of 10 μm or more, the battery 2000 has a sufficient energy density. When the positive electrode 203 has a thickness of 500 μm or less, the battery 2000 can operate at a high power.

The positive electrode active material may be coated with a coating material in order to have a reduced interface resistance against the solid electrolyte. As the coating material, a material with low electron conductivity can be used. As the coating material, the above-mentioned sulfide solid electrolyte, oxide solid electrolyte, halide solid electrolyte, polymer solid electrolyte, or complex hydride solid electrolyte can be used, for example.

The coating material may be an oxide solid electrolyte.

As the oxide solid electrolyte that can be used as the coating material, there can be mentioned a Li—Nb—O compound such as LiNbO₃, a Li—B—O compound such as LiBO₂ and Li₃BO₃, a Li—Al—O compound such as LiAlO₂, a Li—Si—O compound such as Li₄SiO₄, a Li—Ti—O compound such as Li₂SO₄ and Li₄Ti₅O₁₂, a Li—Zr—O compound such as Li₂ZrO₃, a Li—Mo—O compound such as Li₂MoO₃, a Li-V-O compound such as LiV₂O₅, and a Li—W—O compound such as Li₂WO₄. The oxide solid electrolyte has high ionic conductivity. The oxide solid electrolyte has excellent high potential stability. Therefore, use of the oxide solid electrolyte as the coating material can further enhance the charge-discharge efficiency of the battery 2000.

At least one selected from the group consisting of the negative electrode 201, the electrolyte layer 202, and the positive electrode 203 may include a binder to enhance the adhesion between the particles. The binder is used, for example, to enhance the binding properties of the material of an electrode. Examples of the binder include polyvinylidene fluoride, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinylpyrrolidone, polyether, polyethersulfone, hexafluoropolypropylene, styrene-butadiene rubber, and carboxymethylcellulose. As the binder can be used a copolymer of two or more materials selected from tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. A mixture of two or more materials selected from these may also be used as the binder.

At least one of the negative electrode 201 and the positive electrode 203 may include a conductive additive 140 to enhance the electronic conductivity. As the conductive additive 140 can be used, for example: graphite such as natural graphite and artificial graphite; carbon black such as acetylene black and ketjen black; conductive fibers such as a carbon fiber and a metal fiber; fluorinated carbon; metal powders such as an aluminum powder; conductive whiskers such as a zinc oxide whisker and a potassium titanate whisker; conductive metal oxides such as titanium oxide; and conductive polymer compounds such as polyaniline, polypyrrole, and polythiophene. Using the conductive additive 140 that is carbon-based can seek cost reduction.

In the example shown in FIG. 3, the conductive additive 140 is included in the negative electrode 201. However, the conductive additive 140 is not an essential element.

Examples of a shape of the battery 2000 include coin-type, cylindrical-type, prismatic-type, sheet-type, button-type, flat-type, and layer-built-type.

### <Method for Producing Battery>

The battery 2000 using the negative electrode active material 1000 can be produced in the following manner (a dry method), for example.

A powder of the solid electrolyte is put in a ceramic mold. The powder of the solid electrolyte is pressed to form the electrolyte layer 202. A powder of the negative electrode material is put therein to be on one side of the electrolyte layer 202. The powder of the negative electrode material is pressed to form a negative electrode active material layer on the electrolyte layer 202. The negative electrode material includes the negative electrode active material 1000 and the second solid electrolyte 130. A powder of the positive electrode material is put therein to be on the other side of the electrolyte layer 202. The powder of the positive electrode material is pressed to form a positive electrode active material layer. Thereby, a power generation element including the negative electrode active material layer, the electrolyte layer 202, and the positive electrode active material layer can be obtained.

Current collectors are disposed on each of the top and bottom of the power generation element, and a current collector lead is fixed to each of the current collectors. Thereby, the battery 2000 can be obtained.

The battery 2000 using the negative electrode active material 1000 can be also produced by a wet method. For example, in the wet method, a negative electrode slurry including the negative electrode active material 1000 and the second solid electrolyte 130 is applied onto a current collector to form a coating film. Next, the coating film is made go through rolls or a flat plate press heated to a temperature of 120° C. or higher and is pressed. Thereby, a negative electrode active material layer can be obtained. The electrolyte layer 202 and a positive electrode active material layer are produced in the same manner. Next, the negative electrode active material layer, the electrolyte layer 202, and the positive electrode active material layer are stacked in this order. Thereby, a power generation element can be obtained.

### EXAMPLES

Hereinafter, the details of the present disclosure will be described with reference to examples and comparative examples. The following Examples describe examples, and the present disclosure is not limited to the following Examples.

### Example 1

### [Production of Porous Silicon Particles]

Under an argon atmosphere, 0.65 g of silicon fine particles (particle diameter 5 μm, manufactured by Kojundo Chemical Laboratory Co., Ltd.) and 0.60 g of metal Li (manufactured by Honjo Metal Co., Ltd.) were mixed in an agate mortar to obtain a LiSi precursor. In a glass reactor under an argon atmosphere, 1.0 g of the LiSi precursor was allowed to react with 250 mL of 0° C. ethanol (manufactured by NACALAI TESQUE, INC.) for 120 minutes. Thereafter, a first liquid and a first solid reactant were separated from each other by suction filtration. In a glass reactor under an air atmosphere, 0.5 g of the obtained first solid reactant was allowed to react with 50 mL of acetic acid (manufactured by NACALAI TESQUE, INC.) for 60 minutes. Then, a second liquid and a second solid reactant were separated from each other by suction filtration. The second solid reactant was vacuum-dried at 100° C. for 2 hours to obtain porous silicon particles having a three-dimensional network structure. The porous silicon particles had a median size of 0.5 μm. The average pore diameter of the porous silicon particles calculated by the BJH method that is a gas adsorption measurement using nitrogen was 50 nm.

### [Production of Solution L]

As the precursor powder of a first solid electrolyte, powders of Li₂S, P₂S₅, and LiCl were prepared respectively.

Li₂S, P₂S₅, and super dehydrated tetrahydrofuran (THF) were mixed in an argon glove box having a dew point of −60° C. or lower. A molar ratio between Li₂S and P₂S₅ was 3:1. The THF did not include a stabilizer. The resulting mixture was stirred overnight to obtain a THF suspension containing Li₃PS₄.

In an argon glove box, Li₂S and LiCl were dissolved in a super dehydrated ethanol (EtOH) to obtain an EtOH solution. A molar ratio between Li₂S and LiCl was 1:1.

In an argon glove box, the THF suspension and the EtOH solution were mixed to obtain a solution L. In the solution L, a molar ratio between Li₂S, P₂S₅, and LiCl was 5:1:2. The concentration of Li₂S, P₂S₅, and LiCl in the solution L was 4.5 mass %.

### [Production of Negative Electrode Active Material]

In an argon glove box, the porous silicon particles and the solution L were weighed so that the volume ratio of the porous silicon particles:Li₂S, P₂S₅, and LiCl=97.5:2.5. These were then mixed in an agate mortar to bring the porous silicon particles and the solution L into contact with each other. Furthermore, the porous silicon particles and the solution L were kneaded to volatilize a solvent contained in the solution L. Note that the volume ratio between the porous silicon particles and Li₂S, P₂S₅, and LiCl can be considered the volume ratio between the porous silicon particles and Li₆PS₅Cl.

The resulting composite was subjected to a heating treatment at 150° C. for 2 hours under a vacuum atmosphere to obtain a negative electrode active material. The negative electrode active material included Li₆PS₅Cl as the first solid electrolyte.

### [Production of Sulfide Solid Electrolyte A]

Li₂S and P₂S₅ were weighed in an argon glove box having a dew point of −60° C. or lower. A molar ratio between Li₂S and P₂S₅ was 75:25. These were crushed and mixed in an agate mortar to obtain a mixture. Next, the mixture was subjected to milling under the conditions at 510 rpm for 10 hours using a planetary ball mill (Type P-7 manufactured by Fritsch GmbH) to obtain a glassy solid electrolyte. The glassy solid electrolyte was heat-treated under an inert atmosphere under the conditions at 270° C. for 2 hours. Li₂S—P₂S₅, which is a sulfide solid electrolyte A in the form of a glass ceramic, was thereby obtained.

### [Production of Positive Electrode Material B]

As a positive electrode active material, LiNi_{1/3}Co_{1/3}Mn_{1/3}O₂ (manufactured by NICHIA CORPORATION) was used. A surface of the positive electrode active material was subjected to a coating treatment using LiNbO₃. An amount of 1.5 g of the positive electrode active material, 0.023 g of a conductive additive (VGCF manufactured by Showa Denko K.K.), 0.239 g of the sulfide solid electrolyte A, 0.011 g of a binder (PVdF manufactured by KUREHA CORPORATION), 0.8 g of a solvent (butyl butyrate manufactured by KISHIDA CHEMICAL Co., Ltd.) each were weighed out and mixed using an ultrasonic homogenizer (UH-50 manufactured by SMT Co., Ltd.). Thereby, a positive electrode material B was obtained. “VGCF” is a registered trademark of Showa Denko K.K.

### [Production of Negative Electrode Material C]

In an argon glove box having a dew point of −60° C. or lower, 1.02 g of a negative electrode active material, 0.100 g of a conductive additive (VGCF manufactured by Showa Denko K.K.), 0.920 g of the sulfide solid electrolyte A, 0.03 g of a binder (PVdF manufactured by KUREHA CORPORATION), and 2.0 g of a solvent (butyl butyrate manufactured by KISHIDA CHEMICAL Co., Ltd.) each were weighed out and mixed using an ultrasonic homogenizer (UH-50 manufactured by SMT Co., Ltd.). Thereby, a negative electrode material C was obtained.

### [Production of Secondary Battery]

The sulfide solid electrolyte A was weighed to 0.065 g and put in a 1 cm² ceramic mold. The content was pressed at 1 ton/cm² to produce an electrolyte layer.

The positive electrode material B was weighed to 0.030 g and put therein to be on one side of the electrolyte layer. The contents were pressed at 1 ton/cm² to produce a positive electrode active material layer. The negative electrode material C was weighed to 0.030 g and put therein to be on the other side of the electrolyte layer. The contents were pressed at 4 ton/cm² to produce a negative electrode active material layer. Thereby, a power generation element composed of the negative electrode active material layer, the electrolyte layer, and the positive electrode active material layer was obtained.

As a positive electrode current collector, an aluminum foil was disposed on the positive electrode active material layer side of the power generation element, and a current collector lead was fixed thereto. As a negative electrode current collector, a copper foil was disposed on the negative electrode active material layer side of the power generation element, and a current collector lead was fixed thereto. Thereby, a battery of Example 1 was obtained.

### Example 2

In the production process of a negative electrode active material, the porous silicon particles and the solution L were weighed so that the volume ratio of the porous silicon particles:Li₂S, P₂S₅, and LiCl=95.0:5.0. Except for this, a negative electrode active material and a battery of Example 2 were obtained in the same manner as in Example 1.

### Example 3

In the production process of a negative electrode active material, the porous silicon particles and the solution L were weighed so that the volume ratio of the porous silicon particles:Li₂S, P₂S₅, and LiCl=90.0:10.0. Except for this, a negative electrode active material and a battery of Example 3 were obtained in the same manner as in Example 1.

### Comparative Example 1

The porous silicon particles were used as the negative electrode active material without being combined with the first solid electrolyte. That is, the volume ratio between the porous silicon particles and Li₂S, P₂S₅, and LiCl was the porous silicon particles:Li₂S, P₂S₅, and LiCl=100:0. Except for this, a battery of Comparative Example 1 was obtained in the same manner as in Example 1.

### Comparative Example 2

In the production process of a negative electrode active material, the porous silicon particles and the solution L were weighed so that the volume ratio of the porous silicon particles:Li₂S, P₂S₅, and LiCl=85.0:15.0. Except for this, a negative electrode active material and a battery of Comparative Example 2 were obtained in the same manner as in Example 1.

### [SEM Observation on Cross-Section of Negative Electrode Active Material and Measurement of Average Thickness of Thin Film]

A cross-section of the negative electrode active material of Example 1 was observed using an SEM (SU-70 manufactured by Hitachi High-Technologies Corporation), and elemental mapping of S, P, and Cl was performed by EDS. The porous silicon particles included in the negative electrode active material had a three-dimensional network structure, and S, P, and Cl derived from Li₆PS₅Cl serving as the first solid electrolyte were observed in the shape of a thin film along the three-dimensional network structure. It was confirmed that the distribution state of S, P, and Cl was uniform and Li₆PS₅Cl was deposited along the three-dimensional network structure. The thin film of Li₆PS₅Cl measured using a TEM cross-section image had an average thickness of 5 nm. The negative electrode active materials of Examples 2 and 3 as well as Comparative Example 2 were also measured for the average thickness of the thin film of the first solid electrolyte in the same manner. Table 1 shows the results.

### [Measurement of Pore Volume and Specific Surface Area of Negative Electrode Active Material by Nitrogen Absorption Measurement]

The negative electrode active materials of Examples and Comparative Examples were measured for pore volume and specific surface area by the gas adsorption method using a nitrogen gas. Specifically, adsorption isotherm data was obtained using a gas adsorption measurement apparatus using a nitrogen gas (BELLSORP MAX manufactured by MicrotracBEL Corp.). From the obtained adsorption isotherm data, the pore volume at a relative pressure of 0.99 was measured. From the value of the measured pore volume, the ratio of the pore volume of the negative electrode active material to the pore volume of the porous silicon particle (corresponding to the negative electrode active material of Comparative Example 1) was calculated for each of Examples 1 to 3 and Comparative Example 2. In addition, the obtained adsorption isotherm data was converted by a BET adsorption method to calculate the specific surface area. From the value of the calculated specific surface area, the ratio of the specific surface area of the negative electrode active material to the specific surface area of the porous silicon particle (corresponding to the negative electrode active material of Comparative Example 1) was calculated for each of Examples 1 to 3 and Comparative Example 2. Table 1 shows the results.

### [Charging Test]

Next, the batteries of Examples and Comparative Examples were subjected to a charging test under the following conditions.

First, each battery was disposed in a constant-temperature chamber at 25° C. Constant current charge and discharge were performed for the battery under a pressure of 5 MPa applied by a pressurizing jig. The charge final voltage was 4.05 V The discharge final voltage was 2.5 V. The constant current charge and discharge were initially performed at a C-rate of 0.3C and then at a C-rate of 1 C (one hour rate) with respect to a theoretical capacity of the battery. On the basis of the obtained results, the discharge capacity ratio at a C-rate of 0.3C as well as the discharge capacity ratio and the discharge capacity retention rate in the 100th cycle when 100 charge-discharge cycles were performed at a C-rate of 1 C were calculated. Table 1 shows the results. The discharge capacity ratio at a C-rate of 0.3C and the discharge capacity ratio in the 100th cycle in Table 1 are values normalized with respect to the respective values of the battery of Comparative Example 1 as 100. Each discharge capacity retention rate in the 100th cycle in Table 1 is a value when the discharge capacity in the first cycle (before the cycle test) is taken as 100.

TABLE 1

| | | | | Pore | Specific | | | |
|---|---|---|---|---|---|---|---|---|
| | | | | volume | surface | | | |
| | | | | of | area of | | | |
| | | | | negative | negative | | | |
| | | | | electrode | electrode | | | |
| | | | | active | active | | | |
| | | | | material/ | material | Discharge | After 100-cycle test | |
| | | | | Pore | Specific | capacity | at 1 C | |
| | | Volume | Average | volume | surface | ratio at | | Discharge |
| | | ratio of | thickness | of | area of | 0.3 C | Discharge | capacity |
| | First | first solid | of thin | silicon | silicon | before | capacity | retention |
| | solid | electrolyte | film | particle | particle | cycle test | ratio (%) | rate (%) |
| | electrolyte | (%) | (nm) | (%) | (%) | (%) (*1) | (*1) | (*2) |
| Example 1 | Li₆PS₅Cl | 2.5 | 5 | 93 | 87 | 103 | 149 | 58 |
| Example 2 | Li₆PS₅Cl | 5.0 | 9 | 83 | 74 | 105 | 151 | 65 |
| Example 3 | Li₆PS₅Cl | 10 | 21 | 77 | 63 | 101 | 110 | 52 |
| Comparative | Not | — | 0 | 100 | 100 | 100 | 100 | 50 |
| Example | added | | | | | | | |
| 1 | | | | | | | | |
| Comparative | Li₆PS₅Cl | 15 | 31 | 52 | 50 | 96 | 88 | 40 |
| Example | | | | | | | | |
| 2 | | | | | | | | |

(*1) The ratio when that in Comparative Example 1 is taken as 100.
(*2) The discharge capacity ratio in the 100th cycle when the discharge capacity in the first cycle is taken as 100.

### Consideration

In the batteries of Examples 1 to 3, the discharge capacity ratio at a C-rate of 0.3C before the cycle test, and the discharge capacity ratio and the discharge capacity retention rate in the 100th cycle at a C-rate of 1C were all higher than in the battery of Comparative Example 1. This is conceivably because in Examples 1 to 3, the ionic conduction was promoted even into the porous silicon particles in the negative electrode active material, and as a result, charge and discharge reactions were made smoothly in the entire porous silicon particles.

In the battery of Comparative Example 2, the discharge capacity ratio at a C-rate of 0.3C before the cycle test, and the discharge capacity ratio and the discharge capacity retention rate in the 100th cycle at a C-rate of 1 C were all lower than in the batteries of Examples 1 to 3. This is conceivably because in Comparative Example 2, the thin film of the first solid electrolyte had an average thickness of 30 nm or more in the negative electrode active material and thus the first solid electrolyte entered excessively into the pores of the porous silicon particles, and as a result, expansion and shrinkage required for high capacity were unlikely to occur.

### INDUSTRIAL APPLICABILITY

The battery of the present disclosure can be used, for example, as an all-solid-state lithium secondary battery.

What is claimed is:

1. A negative electrode active material comprising:
a porous silicon particle; and
a solid electrolyte, wherein
the porous silicon particle has a plurality of pores,
the solid electrolyte has a shape of a thin film that covers at least a part of an inner surface of each of the pores, and
the thin film has an average thickness of less than 30 nm.

2. The negative electrode active material according to claim 1, wherein
a ratio of a pore volume of the negative electrode active material to a pore volume of the porous silicon particle is 55% or more and less than 99%.

3. The negative electrode active material according to claim 1, wherein
a ratio of a specific surface area of the negative electrode active material to a specific surface area of the porous silicon particle is 55% or more and less than 99%.

4. The negative electrode active material according to claim 1, wherein
a ratio of a volume of the solid electrolyte to a volume of the porous silicon particle is 0.5% or more and less than 15%.

5. The negative electrode active material according to claim 1, wherein
the solid electrolyte includes lithium, phosphorus, sulfur, and halogen.

6. The negative electrode active material according to claim 1, wherein
the thin film has an average thickness of 3 nm or more.

7. A battery comprising:
a negative electrode;
a positive electrode; and
an electrolyte layer disposed between the negative electrode and the positive electrode, wherein
the negative electrode includes the negative electrode active material according to claim 1.
